(19) United States
(12) Patent Application Publication
(10) Pub. No.: US 2006/0210044 A1
(43) Pub. Date: Sep. 21, 2006

(54) Automated conference call outdial security method

(75) Inventor: Ian J. Widger, Bellevue, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Encounter Collaborative Corporation, Portland, OR (US)

(21) Appl. No.: 11/370,601

(22) Filed: Mar. 8, 2006

Related U.S. Application Data
(60) Provisional application No. 60/661,432, filed on Mar. 8, 2005.

(51) Int. Cl. H04M 3/42

(52) U.S. Cl. 379/202.01

(57) ABSTRACT

Described a conference call method and system that automatically and securely establishes a conference call without requiring participants to call in to a telephone company. The method and system include a security device to ensure that each of the parties called by the service provider is authorized to be one of the participants of the conference call. In particular, each participant is provided with a security identifier such as a personal identification number (PIN), password, voice identification (“PASSKEY”), or other identifier. The security identifier can be uniquely assigned to one participant or all of the participants can share the same identifier. To establish a conference call, a telephone service provider simultaneously calls each of the participants at the scheduled time of the conference call. Each participant provides the security identifier to the service provider and is connected into the conference call after authentication of the security identifier. Such a method alleviates the burden of each participant in that participants do not need to retain a telephone number, call the telephone number, or wait for other participants to call in to the conference call. Moreover, the security identifier prevents unauthorized parties from participating in the conference call.

### BACKGROUND OF THE INVENTION

1. Field of the Invention

The invention relates to voice communications, and in particular, to methods and systems for providing a secure conference call between plural participants.

2. Description of the Related Art

Existing communication systems enable telephone conference calls to be established between multiple participants. Typical conferencing systems have three main varieties:

(1) A participant/host makes a reservation for a conference call by contacting a voice operator of a telephone company and telling the operator the date and time at which the conference call is desired. The operator gives the host a telephone number of a bridge of the telephone company and an access code to be used to establish the conference call at the desired date/time. The host sends the telephone number and access code to each of the participants prior to the scheduled date/time. At the scheduled date/time, each of the participants calls the telephone number to access the telephone company bridge and provides the access code. Once all of the participants have called in, the telephone company bridge connects the telephone lines of the participants to establish the conference call.

(2) A participant/host has access to an automated or an “always on” conference call bridge, either through a telephone company provider or by purchasing and installing such a system in its offices. If it is an automated scheduled system, the participant/host schedules the call and selects or is given an access telephone number and an access code. If it is an “always on” system, the participant/host usually has already selected an access telephone number and an access code. In either case, the participant/host sends the access telephone number and an access code to each of the participants prior to the scheduled date/time. At the scheduled date/time, each of the participants calls the telephone number to access the telephone company bridge and provides the access code. Once all of the participants have called in, the telephone company bridge connects the telephone lines of the participants to establish the conference call.

(3) A participant/host makes a reservation for a conference call by contacting a voice operator of a telephone company and telling the operator the date and time at which the conference call is desired. At the scheduled date/time, the operator calls each of the participants and places each participant on the telephone company bridge to establish the conference call.

Such existing conference calling systems are inconvenient in several respects. Requiring each of the participants to retain both the telephone number and access code until the scheduled conference time and call in to the telephone company to start the conference call can be a hassle. Having a live operator place each call is usually very expensive and time consuming. In addition, each participant is either called sequentially by the operator (or each participant calls in at different times given that the participants' watches/clock generally are not synchronized). As such, the first participant generally has to wait for all of the other participants to call in, which is both a waste of time and a waste of money given the per minute charges of the telephone company.

### BRIEF SUMMARY OF THE INVENTION

One embodiment of the invention is directed to a conference call method and system that automatically and securely establishes a conference call without a live operator or requiring participants to call in to a telephone company. The method and system include a security device to ensure that each of the parties called by the service provider is authorized to be one of the participants of the conference call. In particular, each participant is provided with a security identifier such as a personal identification number (PIN), password, voice identification (“PASSKEY”), or other identifier. The security identifier can be uniquely assigned to one participant or all of the participants can share the same identifier.

To establish a conference call, a telephone service provider simultaneously or sequentially calls each of the participants at the scheduled time of the conference call using an automated system. Each participant provides the security identifier to the service provider in response to a automated voice response system and is connected into the conference call after authentication of the security identifier. Such a method alleviates the burden of each participant in that participants do not need to retain a telephone number, call the telephone number, or wait for other participants to call in to the conference call. Moreover, the security identifier prevents unauthorized parties from participating in the conference call.

### BRIEF DESCRIPTION OF THE SEVERAL VIEWS OF THE DRAWINGS

FIG. 1 is a schematic diagram of a conference call system including an out-dial security system according to one embodiment of the invention.

FIG. 2 is a schematic block diagram of an application control server used in the conference call system of FIG. 1.

FIG. 3 is a block diagram of a computing environment that could be employed to implement a method according to the invention.

### DETAILED DESCRIPTION OF THE INVENTION

One embodiment of the invention includes a feature that could be used in a system or as a service whereby a personal identification number (PIN), password or other identification technique such as voice identification (“PASSKEY”) is transmitted to a participant to a conference call either before or at the initiation of the call. At the time the call is being established, the conference bridge calls the participant's phone number and challenges the party who answers the call to enter the PASSKEY or speak the PASSKEY to establish that such party is the participant. This embodiment can be applied to any voice call, whether it is over TDM, wireless, VOIP, or other method.

This first step of the process is the generation of a PASSKEY which may be accomplished by an administrator, by the conference host or automatically by the conference bridge.

The PASSKEY can be entered into the conference bridge by web, telephone keypad, voice recognition or computer application.

The PASSKEY may be any of the following:

a PIN or password provided by the host or administrator;

a PIN or password randomly generated by the system and transmitted to the participant in advance;

in the form of a question, such as name and company name, which is asked by the conference bridge system and is based upon information held in any database, such as Outlook, SQL or Exchange; or

an instruction to the participant to go to a web page and enter a PASSKEY in a specified part of the web page.

The PASSKEY could be the same PASSKEY for all participants or could be that each participant has their own PASSKEY.

The second step is to provide the PASSKEY to the conference participants. This could be done ahead of time via email or instant messaging or dynamically at the time the conference begins through the web site on which the participant has logged in.

Limiting where the conference bridge can call may be a configurable part of the process. These limitations may be imposed by:

the host (or company administrator) for whom the conference call is being established; or

the telephony service provider based upon various reasons such as service package purchased by the host or host company, geographical limitation of the provider's service facilities, legal or contractual requirements, or the host company not having sufficient credit established with the service provider.

The third step is for the conference bridge to place calls to the conference participants and, using voice response (IVR), ask the conference participants to provide the PASSKEY which may be by speech, keypad entry or keyboard entry, as applicable.

The fourth step is to either authenticate the participant and enter them into the conference or reject the participant in which case the system allows the participant a configurable number of retries before disconnecting.

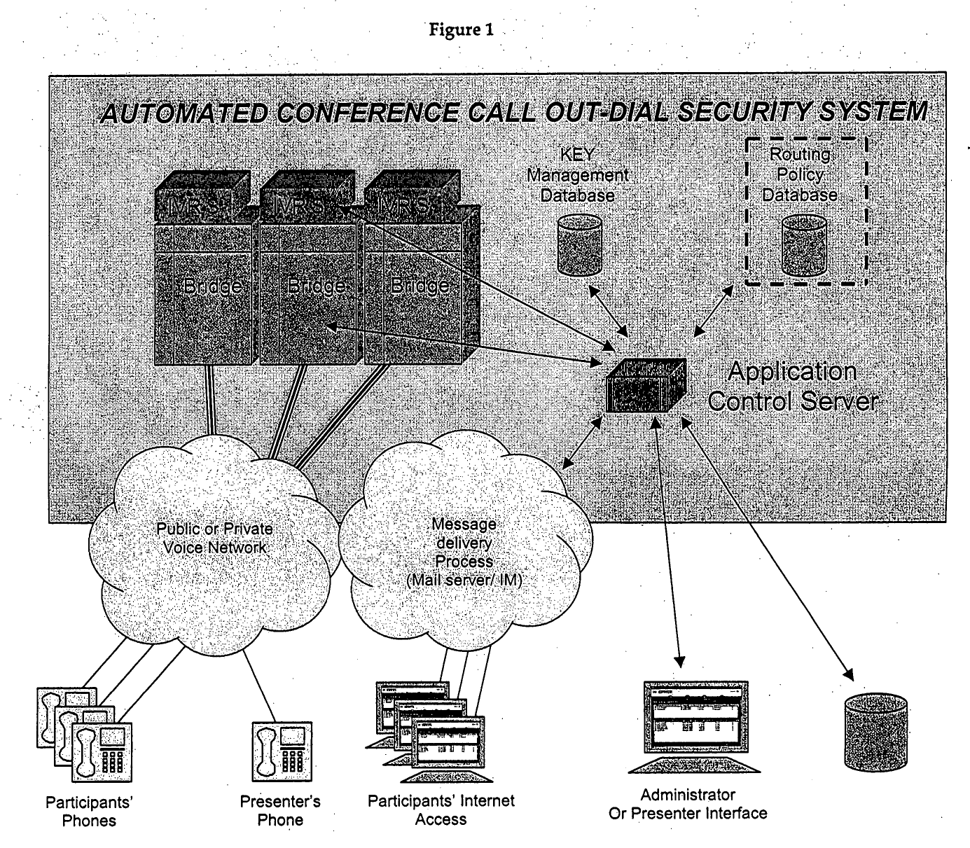

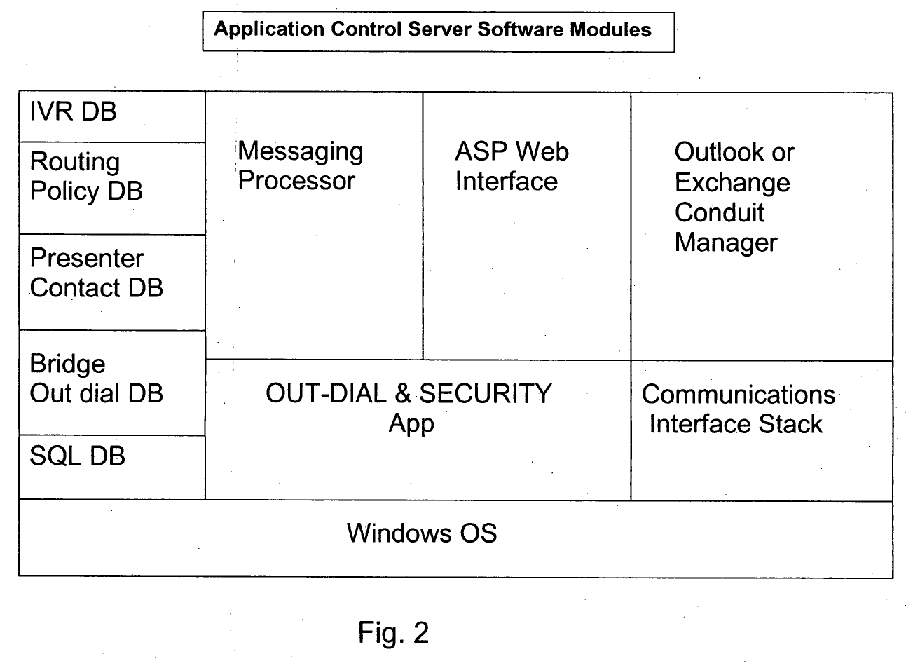

FIG. 1 shows a typical system that would be able used to implement the call conferencing service with the automated conference outdial security method outlined above. In FIG. 1, the shaded area shows the part of the system that would be provided either by a network service provider or as a standalone system for installation at a customer premise. FIG. 2 shows the software modules that reside on the Application Control Server (ACS) that serves as the controller for this system.

The system includes the ACS which is connected to a conference call bridging system or systems (Bridge) with one or more interactive voice response units (IVRs), a database for managing the KEYs (KEY Management Database (KEY DB)), and an optional Routing Policy Database. The system is connected to a public or private voice network (which could be TDM or VOIP) and a network for sending messages to the call participants, and a network for access to a database containing contact information for the conference call participants.

In a typical implementation, the administrator or conference call presenter (Host) will set-up a conference call using a graphical user interface. This could be for an immediate conference call or a conference call in the future. The Host will enter the participants and their contact information (perhaps using data in a contact database, such as, but not limited to, Microsoft Outlook or Exchange contact list using the Outlook or Exchange Conduit Manager), and select the KEY to be used (PASSKEY, DATAKEY or VOICEKEY). If a PASSKEY is used, the Host will choose a PASSKEY or have the PASSKEY selected by a random number generator in the Window OS. If a DATAKEY is used, the Host can select the data for the query or have the ACS select data using predetermined parameters. If a VOICEKEY is used, the voiceprint would be selected from the appropriate database. The KEY information would typically be stored in a KEY DB for access by the ACS at the time of the call.

To initiate the call, the Host can either initiate the conference call manually (even at the end of the call set-up process) or the call can be scheduled to begin automatically at another time. The ACS will signal the Bridge through the Out-dial & Security Application using data in the Bridge Out dial DB to place calls to the participants (simultaneously or sequentially) and, using the IVRs and information stored in the IVR DB, challenge the person who answers the call with a request for input in response to the questions posed by the IVR (i.e., request for a PASSKEY, pose questions and compare answers to questions to those stored as the DATAKEY, or input to test against the VOICEKEY). If the KEY is verified, the ACS through the Out dial & Security Application enter the call leg to the participant into the conference call on the Bridge (or the leg may be parked for entry into the conference call when the Host joins the call).

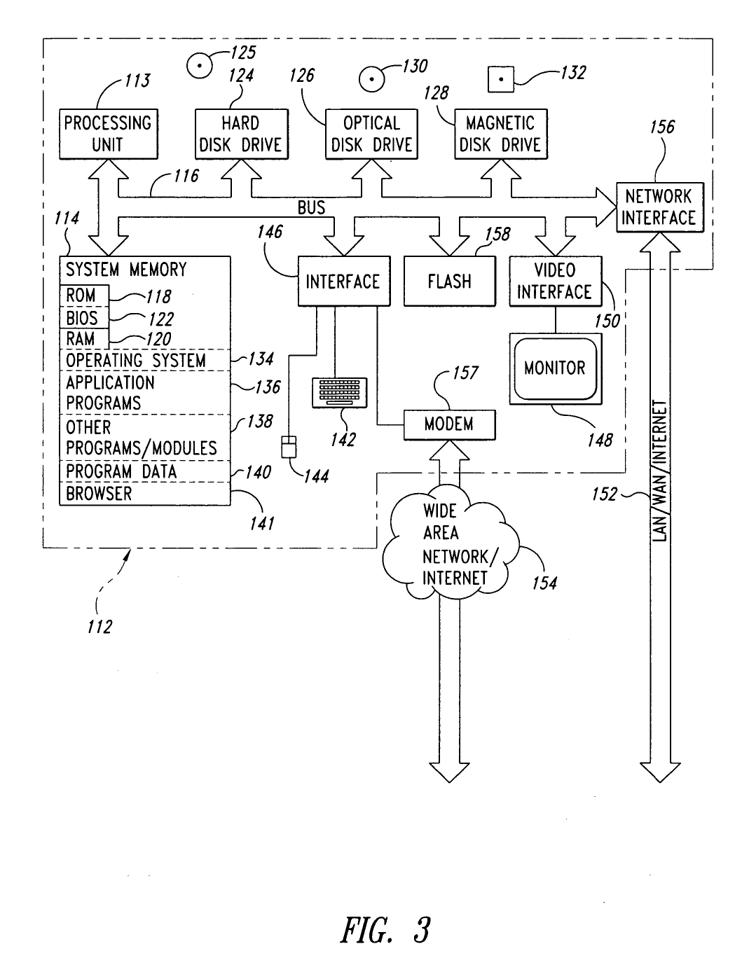

Those skilled in the art will recognize that the method described above may be implemented in a general purpose computer system. FIG. 3 and the following discussion provide a brief, general description of a suitable computing environment in which the invention may be implemented. Although not required, at least one embodiment of the invention can be implemented in the general context of computer-executable instructions, such as program application modules, objects, or macros being executed by a personal computer. Those skilled in the relevant art will appreciate that the invention can be practiced with other computing system configurations, including handheld devices, multiprocessor systems, microprocessor-based or programmable consumer electronics, network PCs, minicomputers, mainframe computers, and the like. The invention can be practiced in distributed computing environments where tasks or modules are performed by remote processing devices, which are linked through a communications network. In a distributed computing environment, program modules may be located in both local and remote memory storage devices.

Referring to FIG. 3, a personal computer referred to herein as a computing system 112 includes a processing unit 113, a system memory 114 and a system bus 116 that couples various system components including the system memory 114 to the processing unit 113. The processing unit 113 may be any logical processing unit, such as one or more central processing units (CPUs), digital signal processors (DSPs), application-specific integrated circuits (ASIC), etc. Unless described otherwise, the construction and operation of the various blocks shown in FIG. 3 are of conventional design. As a result, such blocks need not be described in further detail herein, as they will be understood by those skilled in the relevant art.

The system bus 116 can employ any known bus structures or architectures, including a memory bus with memory controller, a peripheral bus, and/or a local bus. The system memory 114 includes read-only memory (“ROM”) 118 and random access memory (“RAM”) 120. A basic input/output system (“BIOS”) 122, which can form part of the ROM 118, contains basic routines that help transfer information between elements within the computing system 112, such as during startup.

The computing system 112 also includes one or more spinning media memories such as a hard disk drive 124 for reading from and writing to a hard disk 125, and an optical disk drive 126 and a magnetic disk drive 128 for reading from and writing to removable optical disks 130 and magnetic disks 132, respectively. The optical disk 130 can be a CD-ROM, while the magnetic disk 132 can be a magnetic floppy disk or diskette. The hard disk drive 124, optical disk drive 126 and magnetic disk drive 128 communicate with the processing unit 113 via the bus 116. The hard disk drive 124, optical disk drive 126 and magnetic disk drive 128 may include interfaces or controllers coupled between such drives and the bus 116, as is known by those skilled in the relevant art, for example via an IDE (i.e., Integrated Drive Electronics) interface. The drives 124, 126 and 128, and their associated computer-readable media, provide nonvolatile storage of computer-readable instructions, data structures, program modules and other data for the computing system 112. Although the depicted computing system 112 employs hard disk 125, optical disk 130 and magnetic disk 132, those skilled in the relevant art will appreciate that other types of spinning media memory computer-readable media may be employed, such as, digital video disks (“DVD”), Bernoulli cartridges, etc.

Program modules can be stored in the system memory 114, such as an operating system 134, one or more application programs 136, other programs or modules 138, and program data 140. The system memory 14 also includes a browser 141 for permitting the computing system 112 to access and exchange data with sources such as websites of the Internet, corporate intranets, or other networks, as well as other server applications on server computers. The browser 141 is markup language based, such as hypertext markup language (“HTML”), and operate with markup languages that use syntactically delimited characters added to the data of a document to represent the structure of the document.

While shown in FIG. 3 as being stored in the system memory, the operating system 134, application programs 136, other program modules 138, program data 140 and browser 141 can be stored on the hard disk 125 of the hard disk drive 24, the optical disk 130 and the optical disk drive 126 and/or the magnetic disk 132 of the magnetic disk drive 128. A user can enter commands and information to the computing system 112 through input devices such as a keyboard 142 and a pointing device such as a mouse 144. Other input devices can include a microphone, joystick, game pad, scanner, etc. These and other input devices are connected to the processing unit 113 through an interface 146 such as a serial port interface that couples to the bus 116, although other interfaces such as a parallel port, a game port or a universal serial bus (“USB”) can be used. A monitor 148 or other display devices may be coupled to the bus 116 via video interface 150, such as a video adapter. The computing system 112 can include other output devices such as speakers, printers, etc.

The computing system 112 can operate in a networked environment using logical connections to one or more remote computers. The computing system 112 may employ any known means of communications, such as through a local area network (“LAN”) 152 or a wide area network (“WAN”) or the Internet 154. Such networking environments are well known in enterprise-wide computer networks, intranets, and the Internet.

When used in a LAN networking environment, the computing system 112 is connected to the LAN 152 through an adapter or network interface 156 (communicatively linked to the bus 116). When used in a WAN networking environment, the computing system 112 often includes a modem 157 or other device for establishing communications over the WAN/Internet 154. The modem 157 is shown in FIG. 3 as communicatively linked between the interface 146 and the WAN/Internet 154. In a networked environment, program modules, application programs, or data, or portions thereof, can be stored in a server computer (not shown). Those skilled in the relevant art will readily recognize that the network connections shown in FIG. 3 are only some examples of establishing communication links between computers, and other links may be used, including wireless links.

The computing system 112 may include one or more interfaces to allow the addition of devices either internally or externally to the computing system 112. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory.

The term “computer-readable medium” as used herein refers to any medium that participates in providing instructions to processing unit 113 for execution. Such a medium may take many forms, including but not limited to, non-volatile media, volatile media, and transmission media. Non-volatile media includes, for example, hard, optical or magnetic disks 125, 130, 132, respectively. Volatile media includes dynamic memory, such as system memory 114. Transmission media includes coaxial cables, copper wire and fiber optics, including the wires that comprise system bus 116. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processing unit 113 for execution. For example, the instructions may initially be carried on a magnetic disk of a remote computer. The remote computer can load the instructions into its dynamic memory and send the instructions over a telephone line using a modem. The modem 157 local to computer system 112 can receive the data on the telephone line and use an infrared transmitter to convert the data to an infrared signal. An infrared detector coupled to the system bus 116 can receive the data carried in the infrared signal and place the data on system bus 116. The system bus 116 carries the data to system memory 114, from which processing unit 113 retrieves and executes the instructions. The instructions received by system memory 114 may optionally be stored on storage device either before or after execution by processing unit 113. For example, the system can include a flash memory 158 that stores the instructions for implementing the method described above. The method could be implemented using the main processing unit 113 or a separate processor/controller that could be incorporated within the flash memory device or added to the computer system 112 and coupled to the bus 116.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of implementing a conference call among a plurality of participants, the method comprising:
placing a call to each of the participants;
receiving from each participant a security identifier;
authenticating each participant using the security identifier; and
connecting into the conference call each participant that has been successfully authenticated.

2. The method of claim 1 wherein the security identifier includes a voice identifier.

3. The method of claim 1 wherein the security identifier is shared by all of the participants.

4. The method of claim 1 wherein the security identifier for each participant is different from the security identifier for the other participants.

5. A system implementing a conference call among a plurality of participants, the system comprising:
means for placing a call to each of the participants;
means for receiving from each participant a security identifier;
means for authenticating each participant using the security identifier; and
means for connecting into the conference call each participant that has been successfully authenticated.
